(19) United States
(12) Patent Application Publication
(10) Pub. No.: US 2022/0357478 A1
(43) Pub. Date: Nov. 10, 2022

(54) SEABED GEOTECHNICAL IN-SITU MULTI-PARAMETER DETECTION SYSTEM AND METHOD

(71) Applicant: ZHEJIANG UNIVERSITY, Hangzhou, Zhejiang (CN)

(72) Inventors: Jiawang CHEN, Hangzhou, Zhejiang (CN); Ziqiang REN, Hangzhou, Zhejiang (CN); Lizhong WANG, Hangzhou, Zhejiang (CN); Dongrui RUAN, Hangzhou, Zhejiang (CN); Yi HONG, Hangzhou, Zhejiang (CN); Kai HE, Hangzhou, Zhejiang (CN); Feng GAO, Hangzhou, Zhejiang (CN); Peng ZHOU, Hangzhou, Zhejiang (CN); Tao LIANG, Hangzhou, Zhejiang (CN)

(21) Appl. No.: 17/630,981

(22) PCT Filed: Sep. 15, 2021
(86) PCT No.: PCT/CN2021/118463

§ 371 Date: Jan. 28, 2022

(30) Foreign Application Priority Data
Nov. 30, 2020 (CN) 202011376624.5

(51) Int. Cl. G01V 11/00; G01V 3/00

(52) U.S. Cl. CPC G01V 11/00; G01V 3/00; E02D 1/022

(57) ABSTRACT

The disclosure relates to the field of ocean engineering technical equipment, and specifically relates to a seabed geotechnical in-situ multi-parameter detection system and method. The system comprises two friction wheels symmetrically arranged in an integral frame, and collimating mechanisms are arranged above and below the butt joint position of the two friction wheels; a winch is fixedly arranged on the bottom surface of the integral frame on the rear side of the friction wheels, and a winch rotating wheel is connected with a servo motor; a flexible probe rod comprises multiple sections of rigid rod pieces connected through armored cables, a static sounding probe is connected with one end of the flexible probe rod, the flexible probe rod is wound on the winch, the end with the static sounding probe sequentially penetrates through a butt joint device and the collimating mechanism and then enters the space between the two friction wheels, and finally the static sounding probe penetrates into a soil body downwards. The system is high in stability.

### CROSS REFERENCE TO RELATED APPLICATION(S)

This patent application is a national stage application of International Patent Application No. PCT/CN2021/118463, filed on Sep. 15, 2021, which claims the benefit and priority of Chinese Patent Application No. 202011376624.5 filed on Nov. 30, 2020, the disclosure of which is incorporated by reference herein in its entirety as part of the present application.

### TECHNICAL FIELD

The disclosure relates to the field of ocean engineering technical equipment, in particular to a seabed geotechnical in-situ multi-parameter detection system and method.

### BACKGROUND ART

Investigation and research of seabed soil mass properties are essential important parts of ocean engineering construction such as offshore oil platforms, seabed tunnels, oil and gas pipelines, optical cables and the like. Research on the properties of sediment soil dozens of meters below the seabed is of great significance in the aspects of marine environment investigation, seabed resource exploration, marine development and utilization and the like. Under the ocean extreme environment load, the foundation collapse or excessive inclination of the offshore structure happens frequently, so that the redundancy of conventional design is too high. Safe and economical ocean engineering structure foundation design mainly depends on efficient survey and scientific analysis of seabed stratum mechanical properties.

Compared with other ex-situ test methods, the static sounding technology has the characteristics of no sampling in field test, wide application range, rapidness, economy and the like, and shows incomparable superiority in comprehensive analysis and evaluation of engineering geology. When the static sounding technology is applied to submarine soil body exploration, the advantages of the static sounding technology can be better displayed. The seabed soil body, generally a recent sediment, is large in thickness, saturated and loose and easy to disturb, the soil body is disturbed by operations such as drilling and sampling, the soil body is subjected to water loss and pressure loss after field observation or indoor tests after sampling, and therefore, the properties of the in-situ seabed sediment soil body cannot be obtained; and the static sounding technology can obtain more real soil mass properties due to the fact that testing is carried out in the actual environment of the seabed soil mass. And the survey speed is high, the survey efficiency is high, and the advantages are more obvious when large-range submarine soil survey, such as routing survey of submarine cables and oil pipelines, is carried out.

At present, most static sounding technical equipment adopts a straight rigid probe rod with the whole length to directly press a probe into the surface of a seabed, so that radial instability and operation inconvenience are caused, and the static sounding technical equipment is not suitable for exploration of deep seabed sediments; and in addition, due to the adoption of a segmented probe rod mode, manual butt joint is needed, large operation labor requirements exist, and the detection method is only limited to shallow water operation environments and is not suitable for deep sea areas.

Therefore, a seabed geotechnical in-situ multi-parameter detection system is designed, the requirements of accurate survey technology and equipment for seabed soil mass properties are met, survey work of the seabed soil mass properties is carried out under the large working water depth of the deep sea, meanwhile, the survey depth is further improved, and the level of marine geotechnical engineering in-situ survey equipment in China can be improved.

### SUMMARY

The present disclosure aims to provide a seabed geotechnical in-situ multi-parameter detection system and method, and solves the problems of radial instability and operation inconvenience caused by the fact that a probe is directly pressed into the surface of a seabed by adopting a flat and straight rigid probe rod with the whole length in current survey equipment; and by adopting a segmented probe rod mode, manual butt joint is needed, and the system and the method are not suitable for deep sea areas.

In order to solve the technical problems, the present disclosure has the following solutions:

Provided is a seabed geotechnical in-situ multi-parameter detection system, comprising an integral frame, a constant-speed penetration system, flexible probe rods, a butt joint assembly system and a static sounding probe.

The constant-speed penetration system comprises two friction wheels symmetrically arranged in the same vertical plane, and the collimating mechanisms are arranged above and below the butt joint position of the two friction wheels; and a support is arranged on the friction wheel, the support is internally provided with a hydraulic motor, the hydraulic motors are used for driving the symmetrically distributed friction wheels to rotate in opposite direction, so that a probe rod in the middle of the two friction wheels is driven to continuously penetrate into the ground at constant speed. The two supports are connected through a hydraulic locking oil cylinder and used for providing opposite extrusion friction force between the two friction wheels, the two supports are fixedly arranged on the bottom surface in the integral frame through a same base, an energy accumulator is further arranged on the base and connected with the hydraulic motors, and the energy accumulator is used for absorbing pressure impact generated in the hydraulic system due to sudden stop of movement of an actuating element so as to avoid damage to instruments, elements and sealing devices and reduce generated vibration and noise. A hydraulic valve box for providing hydraulic power, a hydraulic pipeline and an underwater motor are further arranged on the bottom surface in the integral frame and are connected with the hydraulic motors and the hydraulic locking oil cylinder; and the friction force of the friction wheels to the probe rod is adjusted through the hydraulic locking oil cylinder, so that the penetration force is adjusted. The hydraulic valve box, the hydraulic pipeline and the underwater motor are used for providing hydraulic power for a hydraulic driving system. The hydraulic valve box controls the rotation speed of the friction wheels, so that the penetration speed of the probe rod is adjusted.

The butt joint assembly system comprises a winch, a butt joint device and a driving rotating wheel; the winch is fixedly arranged on the bottom surface of the integral frame on the rear side of the friction wheels, and the winch rotating wheel is connected with a servo motor; the driving rotating wheel is arranged on a support frame and connected with the servo motor; and the butt joint device is used for carrying out butt joint and disassembly on quick butt joint mechanisms between the adjacent small sections of rigid rod pieces.

The flexible probe rod comprises multiple sections of rigid rod pieces connected through armored cables, and the armored cables can be used for carrying out real-time transmission of signals at the same time. The flexible probe rod is wound on the winch, the static sounding probe is connected with one end of the flexible probe rod, the end penetrates through the butt joint device and then enters the space between the two friction wheels, and finally penetrates into the ground after passing through the collimating mechanism; and the butt joint device is driven by the hydraulic motors, and the probe rod is connected and disassembled by adopting an annular chuck structure. When the static sounding probe penetrates into a seabed soil body, various in-situ geotechnical data can be collected, and the data is transmitted to an underwater electronic cabin in real time through the signal armored cables. The static sounding probe is used for carrying out data collection on multiple in-situ parameters such as cone tip resistance, side wall friction force, pore water pressure and resistivity.

As an improvement, the friction wheels are detachably connected with the supports, a groove is formed in the outer ring of the friction wheel, and lines are arranged on the groove.

As an improvement, the rigid rod piece is of a hollow cylinder structure, and a male plug and a female plug are arranged at the two ends of the rigid rod piece respectively.

As an improvement, the winch comprises a winch rotating frame, the winch rotating frame is installed on the base, annular teeth are arranged on the inner side of the winch rotating frame, and the winch rotating frame is connected with the servo motor through a gear; the base is further provided with a rotating wheel and a guide rail, the rotating wheel is used for supporting and guiding the winch rotating frame during rotation, and the guide rail is used for guiding the flexible probe rod. When the winch works, the winch rotating frame rotates with the circle center of the rotating frame as the axis.

As an improvement, the integral frame comprises a support frame, anti-collision grids and anti-collision rubber strips are arranged outside the support frame, a lifting frame is arranged on the top of the support frame, and an anti-corrosion zinc block is arranged inside the support frame.

As an improvement, a clamping plug is arranged at one end of the male plug; a groove is formed in one end of the female plug, and a clamp spring is embedded in the groove; three notches are evenly formed in the outer edge of the groove, and a clamping jaw is installed at each notch; the clamping jaw is nested on the clamp spring, and the other end of the female plug is connected with a gland through a screw; and the clamping plug of the male plug is plugged into the groove of the female plug, and the clamping spring is used for providing inward tightening acting force to buckle the clamping jaw with the clamping plug on the male plug.

Provided is a seabed geotechnical in-situ multi-parameter detection method, wherein the seabed geotechnical in-situ multi-parameter detection method is applied to a seabed geotechnical in-situ multi-parameter detection system according to any one of above claims, and the seabed geotechnical in-situ multi-parameter detection method comprises the following steps:

in the penetration process of a static sounding probe, controlling a winch in a butt joint assembly system to rotate, so that the winch drives a flexible probe rod to be laid;

controlling a servo motor to drive a driving rotating wheel to rotate, so that the driving rotating wheel drives rigid rod pieces to align with a butt joint device;

controlling a hydraulic locking oil cylinder to drive friction wheels to move in opposite directions, so that the two sides of the flexible probe rod are tightly attached to the friction wheels;

controlling hydraulic motors to drive the friction wheels to rotate so as to drive the flexible probe rod, so that the static sounding probe penetrates into a measured soil body; and

in the recovery process of the static sounding probe, controlling the hydraulic motors to rotate reversely to drive the friction wheels to drive the flexible probe rod so that the static sounding probe is pulled out upwards, meanwhile, controlling the butt joint device to open quick butt joint mechanisms between the adjacent flexible probe rods, dividing the straight probe rod into two sections of rigid rod pieces, and winding the rigid rod pieces on the winch after passing through the driving rotating wheel.

Compared with the prior art, the present disclosure has the following beneficial effects:

Firstly, compared with the problems of radial instability and operation inconvenience caused by the fact that a probe is directly pressed into the surface of a seabed through a flat and straight rigid probe rod with the whole length, the adopted flexible probe rod mode is high in stability.

Secondly, compared with a segmented probe rod mode, manual butt joint is needed, the operation labor requirement is large, the device is not suitable for the deep sea environment, manual butt joint is not needed, the labor intensity is reduced, and seabed static sounding operation in the deep sea environment can be carried out. A rigid straight probe rod is formed by using the flexible probe rod, the friction wheels move in opposite directions to pressurize the straight probe rod, meanwhile, the friction wheels rotate so that the probe rod penetrates into a measured soil body, the collimation degree and the penetration pressure needed when the probe rod penetrates into the soil body for detection are guaranteed, and the stability in the static sounding process is guaranteed.

### BRIEF DESCRIPTION OF THE DRAWINGS

To describe the technical scheme in the embodiments of the present disclosure or in the prior art more clearly, the following briefly introduces the attached figures required for describing the embodiments. Apparently, the attached figures in the following description show merely some embodiments of the present disclosure, and those skilled in the art may still derive other attached figures from these attached figures without creative efforts.

FIG. 1 is an integral external schematic diagram of a seabed geotechnical in-situ multi-parameter detection system provided by the present disclosure;

FIG. 2 is a structural schematic diagram of a seabed geotechnical in-situ multi-parameter detection system provided by the present disclosure;

FIG. 3 is a partial schematic diagram of a seabed geotechnical in-situ multi-parameter detection system provided by the present disclosure;

FIG. 4 is a structural schematic diagram of a butt joint device provided by the present disclosure;

FIG. 5 is an upward view of a butt joint device provided by the present disclosure;

FIG. 6 is a structural schematic diagram of a collimating mechanism provided by the present disclosure;

FIG. 7 is a structural schematic diagram of a winch provided by the present disclosure;

FIG. 8 is a structural schematic diagram of a rigid rod piece provided by the present disclosure;

FIG. 9 is a structural schematic diagram of a female plug provided by the present disclosure; and

FIG. 10 is a structural schematic diagram of a male plug provided by the present disclosure.

Reference signs: 1, integral frame; 1-1, lifting frame; 1-2, support frame; 1-3, anti-collision rubber strip; 1-4, anti-collision grid; 2, constant-speed penetration system; 2-1, friction wheel; 2-2, support; 2-3, hydraulic motor; 2-4, base; 2-5, energy accumulator; 2-6, butt joint device; 2-7, hydraulic locking oil cylinder; 2-8, collimating mechanism; 3, hydraulic valve box; 4, electronic cabin; 5, static sounding probe; 6, servo motor; 7, driving rotating wheel; 8, winch; 8-1, winch rotating frame; 8-2, servo motor; 8-3, rotating wheel; 8-4, guide rail; 8-5, annular tooth; 8-6, gear; 8-7, base; 9, flexible probe rod; 9-1, male plug; 9-2, rigid rod piece; 9-3, female plug; 9-4, clamping jaw; 9-5, clamping spring; 9-6, gland; 9-7, screw; and 10, underwater motor.

### DETAILED DESCRIPTION OF THE EMBODIMENTS

The following clearly and completely describes the technical scheme in the embodiments of the present disclosure with reference to the attached figures in the embodiments of the present disclosure. Apparently, the described embodiments are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

To make the foregoing objective, features and advantages of the present disclosure clearer and more comprehensible, the present disclosure is further described in detail below with reference to the attached figures and specific embodiments.

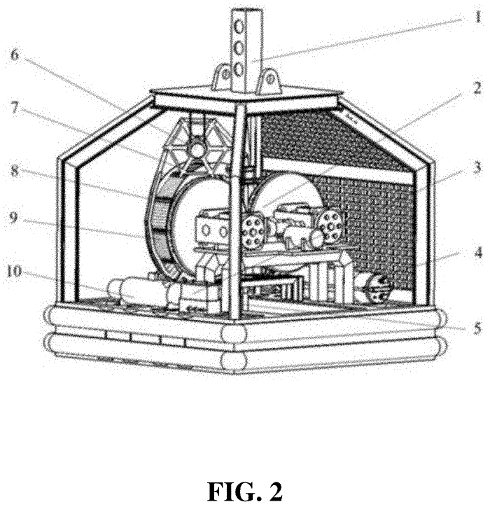

As shown in FIG. 2, provided is a seabed geotechnical in-situ multi-parameter detection system, comprising an integral frame, a constant-speed penetration system, flexible probe rods, a butt joint assembly system and a static sounding probe.

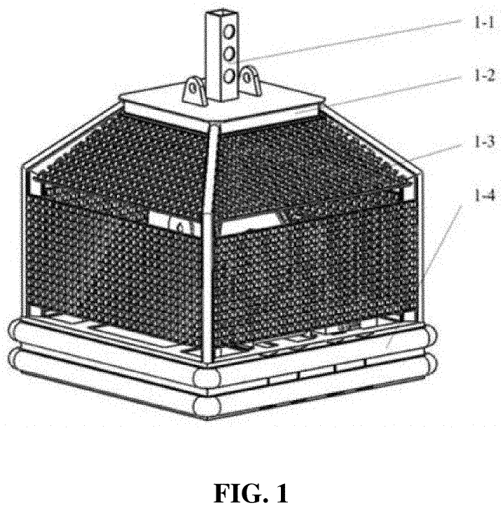

As shown in FIG. 1, the integral frame 1 is composed of a lifting frame 1-1, a support frame 1-2, anti-collision rubber strips 1-3 and anti-collision grids 1-4 and is used for supporting, installing and protecting integral equipment, and the structure of the integral frame can be designed according to actual needs. In the embodiment, the support frame 1-2 comprises supporting and installing supports of each mechanism. The lifting frame 1-1 is welded to the top of the support frame 1-2, the anti-collision rubber strips 1-3 are installed on the inner side of the support frame 1-2, and the anti-collision rubber strips 1-3 and the anti-collision grids 1-4 which are used for protecting the equipment are arranged on the outer side of the support frame 1-2.

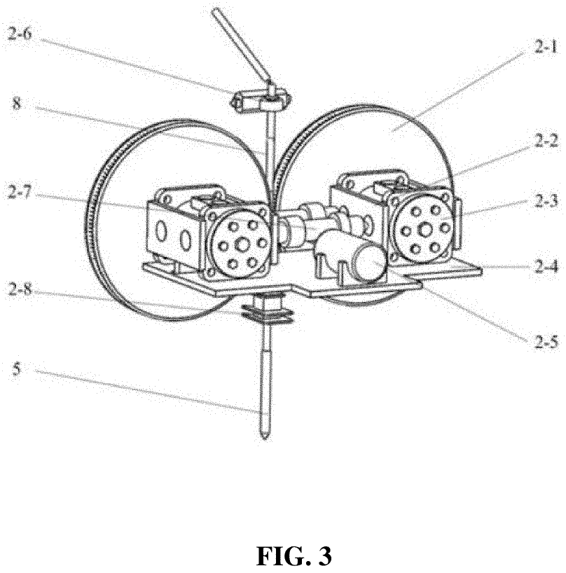

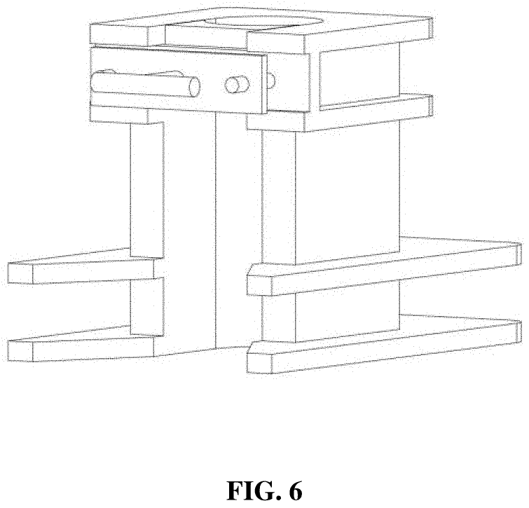

As shown in FIG. 3, the constant-speed penetration system comprises friction wheels 2-1, supports 2-2, hydraulic motors 2-3, a base 2-4, an energy accumulator 2-5, a butt joint device 2-6, a hydraulic locking oil cylinder 2-7 and collimating mechanisms 2-8. Wherein, the collimating mechanisms 2-8 are as shown in FIG. 6. The hydraulic driving system is composed of hydraulic motors 2-3, a base 2-4, an energy accumulator 2-5 and a hydraulic locking oil cylinder 2-7. The constant-speed penetration system comprises two friction wheels 2-1 symmetrically arranged in the same vertical plane, and the collimating mechanisms 2-8 are arranged above and below the butt joint position of the two friction wheels 2-1, a support 2-2 is arranged on the friction wheel 2-1, the support 2-2 is internally provided with a hydraulic motor 2-3, the hydraulic motors 2-3 are used for driving the friction wheels to rotate. The two supports 2-2 are connected through a hydraulic locking oil cylinder 2-7 and used for providing opposite extrusion friction force between the two friction wheels 2-1, the two supports 2-2 are fixedly arranged on the bottom surface in the integral frame 1 through a same base 2-4, an energy accumulator 2-5 is further arranged on the base 2-4 and connected with the hydraulic motors 2-3, and the energy accumulator is used for absorbing pressure impact generated in the hydraulic system due to sudden stop of movement of an actuating element. A hydraulic valve box 3 for providing hydraulic power, a hydraulic pipeline and an underwater motor 10 are further arranged on the bottom surface in the integral frame 1 and are connected with the hydraulic motors 2-3 and the hydraulic locking oil cylinder 2-7.

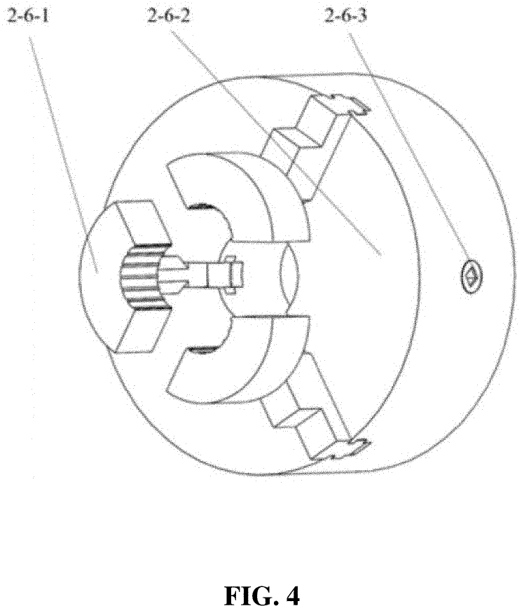

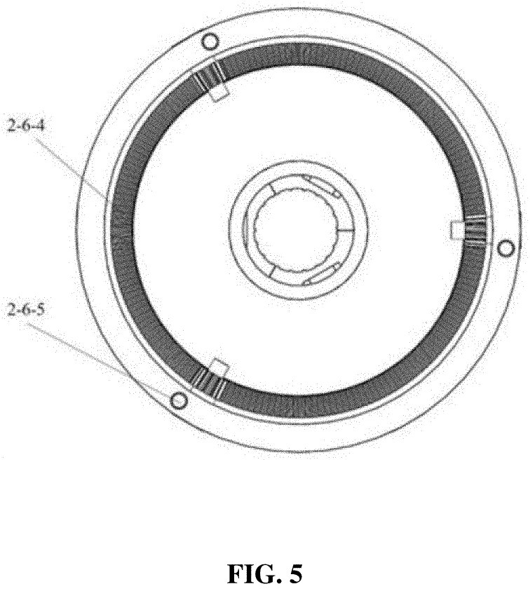

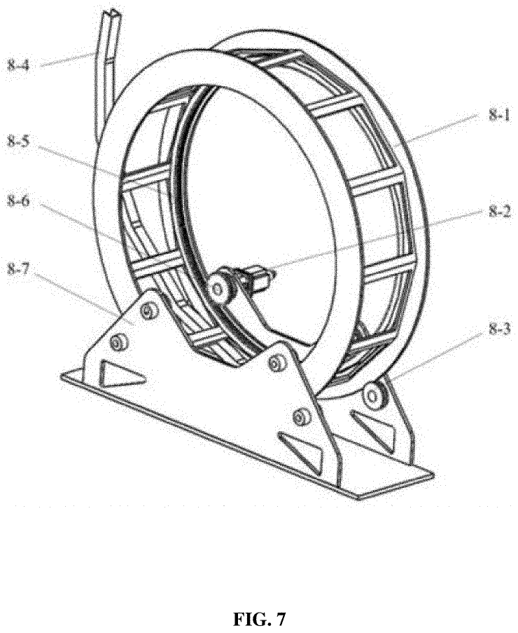

The butt joint assembly system comprises a winch 8, a butt joint device 2-6 and a driving rotating wheel 7, the winch 8 is fixedly arranged on the bottom surface of the integral frame on the rear side of the friction wheels 2-1, and the winch rotating wheel 7 is arranged on the support frame 1-2 and connected with a servo motor 6. As shown in FIG. 7, the winch rotating frame 8-1 is installed on the base 8-7, annular teeth 8-5 are arranged on the inner side of the winch rotating frame 8-1, and the winch rotating frame 8-1 is meshed with a gear 8-6 on the servo motor 8-2. The winch rotating frame 8-1 rolls on the rotating wheel 8-3. As shown in FIG. 4 and FIG. 5, the butt joint device is composed of annular clamping jaws 2-6-1, a chuck 2-6-2, driving gears 2-6-3, a driving disc 2-6-4 and positioning nails 2-6-5. The chuck 2-6-2 is of a structure similar to a cover, a through hole is formed in the center of the top of the chuck 2-6-2 and used for the rigid probe rod 9-2 to pass through, three grooves diverging from the center to the outer edge are evenly formed in the disc surface on the top of the chuck 2-6-2, a plurality of through holes are formed in the side portion of the chuck 2-6-2, and the driving gears 2-6-3 are arranged in the through holes. The groove is internally provided with a clamping jaw seat, an annular clamping jaw 2-6-1 is arranged on each clamping jaw seat, lines are arranged on the opposite sides of the three annular clamping jaws 2-6-1, the annular clamping jaws 2-6-1 can clamp the rigid probe rod 9-2 for butt joint, and when the rigid probe rod 9-2 at the two adjacent ends is detached, the annular clamping jaws 2-6-1 can open quick connecting rod mechanisms on the probe rod. A driving disc 2-6-4 is arranged in the lower portion of the chuck 2-6-2, a hole is formed in the center of the driving disc 2-6-4, a threaded groove is formed in the side wall of the hole, annular teeth are arranged on the outer edge of the driving disc 2-6-4, an extending portion is downwards arranged on the clamping jaw seat, the extending portion extends into the hole in the center of the driving disc 2-6-4, a thread is arranged on the extending portion, and the thread is matched with the threaded groove in the hole of the driving disc 2-6-4, and the driving gears 2-6-3 can be connected with a driving mechanism and are meshed with annular teeth on the side edge of the driving disc 2-6-4. The driving gear 2-6-3 rotates to drive the driving disc 2-6-4 to rotate, and the threaded groove in the driving disc 2-6-4 drives the annular clamping jaw 2-6-1 to move. The static sounding probe 5 is arranged at one end of the flexible probe rod 9, the end, provided with the static sounding probe 5, of the flexible probe rod 9 is led out through the guide rail 8-4 and guided by the driving rotating wheel 7, sequentially penetrates through the butt joint device 2-6 and the collimating mechanisms 2-8 and then enters the space between the two friction wheels 2-1, and finally the static sounding probe 5 is downwards penetrated into a soil body.

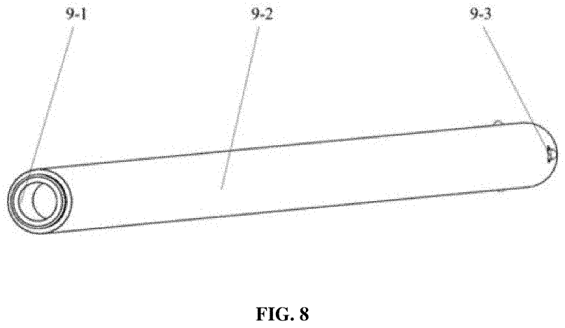

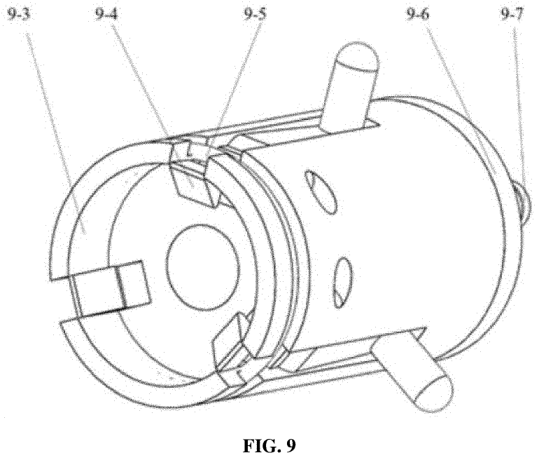

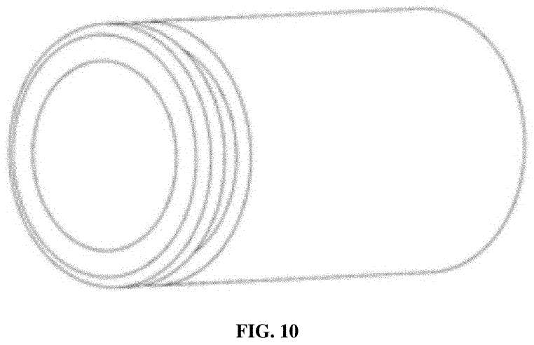

As shown in FIG. 8, the flexible probe rod 9 is formed by butt joint of multiple sections of rigid rod pieces 9-2, armored cables are arranged in the flexible probe rod 9, and quick connecting rod structures are arranged at the two ends of the rigid rod piece 9-2. As shown in FIG. 9 and FIG. 10, the quick butt joint mechanisms comprise male plugs 9-1 and female plugs 9-3, and a clamping plug is arranged at one end of the male plug 9-1. A groove is formed in one end of the female plug 9-3, an annular groove is formed in the outer wall of the groove, three notches are evenly formed in the outer edge of the groove of the clamping spring 9-5, a clamping jaw 9-4 is installed at each notch, the clamping jaw 9-4 is nested on the clamp spring 9-5, and the other end of the female plug 9-3 is connected with a gland 9-6 through a screw 9-7. When the male plug 9-1 and the female plug 9-3 are in butt joint, the clamping plug of the male plug 9-1 is plugged into the groove of the female plug 9-3, the clamping spring 9-5 provides inward tightening acting force, the clamping jaw 9-4 is buckled with the clamping plug on the male plug 9-1, and butt joint of the male plug 9-1 and the female plug 9-2 is achieved.

The present disclosure also provides a seabed geotechnical in-situ multi-parameter detection method, wherein the seabed geotechnical in-situ multi-parameter detection method is applied to a seabed geotechnical in-situ multi-parameter detection system, and the seabed geotechnical in-situ multi-parameter detection method comprises the following steps:

in the penetration process of a static sounding probe, controlling a winch in a butt joint assembly system to rotate, so that the winch drives a flexible probe rod to be laid;

controlling a servo motor to drive a driving rotating wheel to rotate, so that the driving rotating wheel drives rigid rod pieces to align with a butt joint device;

controlling a hydraulic locking oil cylinder to drive friction wheels to move in opposite directions, so that the two sides of the flexible probe rod are tightly attached to the friction wheels;

controlling hydraulic motors to drive the friction wheels to rotate so as to drive the flexible probe rod, so that the static sounding probe penetrates into a measured soil body; and

in the recovery process of the static sounding probe, controlling the hydraulic motors to rotate reversely to drive the friction wheels to drive the flexible probe rod so that the static sounding probe is pulled out upwards, meanwhile, controlling the butt joint device to open quick butt joint mechanisms between the adjacent flexible probe rods, dividing the straight probe rod into two sections of rigid rod pieces, and winding the rigid rod pieces on the winch after passing through the driving rotating wheel.

The working process is as follows:

Firstly, the flexible probe rod 9 is formed by connecting a plurality of rigid rod pieces 9-2 in series, the flexible probe rod 9 is wound on the winch 8, one end of the rigid rod piece 9-2 is wound and connected with the driving rotating wheel 7, the other end of the flexible probe rod 9 bypasses the driving rotating wheel 7 and then penetrates through the butt joint device 2-6, the butt joint device 2-6 is used for connecting the quick butt joint mechanisms between the adjacent flexible probe rods 9, and the flexible probe rods 9 are combined into a straight probe rod.

Secondly, in the penetration process of the static sounding probe 5, the gear installed on the servo motor 8-2 is meshed with the annular teeth 8-5, when the servo motor 21 rotates, the winch 8 is driven to rotate, and the winch 8 drives the flexible probe rod 9 to be laid. The servo motor 6 drives the driving rotating wheel 7 to rotate, the driving rotating wheel 10 drives the rigid rod pieces to be aligned with the butt joint device 2-6, the butt joint device 2-6 enables the rigid rod pieces 9-2 at the two adjacent ends to be in butt joint, and the flexible probe rods 9 are combined into a straight probe rod. The hydraulic locking oil cylinder 2-7 drives the friction wheels 2-1 to move in the opposite direction, so that the two sides of the flexible probe rod 9 are tightly attached to the friction wheels 2-1, and the friction wheels 2-1 can be replaced to be suitable for the flexible probe rods 9 of different sizes. The hydraulic motors 2-3 drive the friction wheels 2-1 to rotate to drive the flexible probe rods 9, so that the static sounding probe 5 penetrates into a measured soil body. The static sounding probe 5 is used for carrying out data collection on multiple in-situ parameters such as cone tip resistance, side wall friction force, pore water pressure and resistivity in the penetration process.

Thirdly, in the recovery process of the static sounding probe 5, the hydraulic motors 2-3 rotate reversely to drive the friction wheels 2-1 to drive the flexible probe rods 9 so that the static sounding probe 5 is pulled out upwards, meanwhile, the butt joint device 2-6 opens the quick butt joint mechanisms between the adjacent flexible probe rods, the straight probe rod is divided into two sections of rigid rod pieces 9-2, and the rigid rod pieces 9-2 are wound on the winch 8 after passing through the driving rotating wheel 7.

All embodiments in this specification are described in a progressive manner. Each embodiment focuses on differences from other embodiments. For the part that is the same or similar between different embodiments, reference may be made between the embodiments. The device disclosed in the embodiment corresponds to the method disclosed in the embodiment, and therefore the description is relatively brief. Related information refers to descriptions of the related parts in the method.

Several examples are used for illustration of the principles and implementation methods of the present disclosure. The description of the embodiments is used to help illustrate the method and the core principles of the present disclosure; and meanwhile, those skilled in the art can make various modifications in terms of specific embodiments and scope of application in accordance with the teachings of the present disclosure. In conclusion, the content of this specification shall not be construed as a limitation to the present disclosure.

1. A seabed geotechnical in-situ multi-parameter detection system, comprising an integral frame, a constant-speed penetration system, a butt joint assembly system, a flexible probe rod and a static sounding probe, wherein
the constant-speed penetration system comprises two friction wheels symmetrically arranged in the same vertical plane, and the collimating mechanisms are arranged above and below the butt joint position of the two friction wheels; a support is arranged on the friction wheel, the support is internally provided with a hydraulic motor, and the hydraulic motors are used for driving the friction wheels to rotate; the two supports are connected through a hydraulic locking oil cylinder and used for providing opposite extrusion friction force between the two friction wheels, the two supports are fixedly arranged on the bottom surface in the integral frame through a same base, and an energy accumulator is further arranged on the base and connected with the hydraulic motors; a hydraulic valve box for providing hydraulic power, a hydraulic pipeline and an underwater motor are further arranged on the bottom surface in the integral frame and are connected with the hydraulic motors and the hydraulic locking oil cylinder;
the butt joint assembly system comprises a winch, a butt joint device and a driving rotating wheel; the winch is fixedly arranged on the bottom surface of the integral frame on the rear side of the friction wheels, the winch rotating wheel is connected with a servo motor, and the driving rotating wheel is arranged on a support frame and connected with the servo motor;
the flexible probe rod comprises multiple sections of rigid rod pieces connected through armored cables, and the static sounding probe is arranged at one end of the flexible probe rod; and the flexible probe rod is wound on the winch, the end with the static sounding probe sequentially penetrates through the driving rotating wheel, the butt joint device and the collimating mechanisms, enters the space between the two friction wheels and finally penetrates into the ground, and the butt joint device is used for connecting and detaching the multiple sections of rigid rod pieces.

2. The seabed geotechnical in-situ multi-parameter detection system according to claim 1, wherein the integral frame comprises a support frame; and anti-collision grids and anti-collision rubber strips are arranged outside the support frame, a lifting frame is arranged on the top of the support frame, and an anti-corrosion zinc block is arranged inside the support frame.

3. The seabed geotechnical in-situ multi-parameter detection system according to claim 1, wherein the friction wheels are detachably connected with the supports, a groove is formed in the outer ring of the friction wheel, and lines are arranged on the groove.

4. The seabed geotechnical in-situ multi-parameter detection system according to claim 1, wherein the rigid rod piece is of a hollow cylinder structure, and quick connecting rod mechanisms are arranged at the two ends of the rigid rod piece respectively.

5. The seabed geotechnical in-situ multi-parameter detection system according to claim 4, wherein the quick connecting rod mechanisms comprise a male plug and a female plug.

6. The seabed geotechnical in-situ multi-parameter detection system according to claim 1, wherein the winch comprises a winch rotating frame, the winch rotating frame is installed on the base, annular teeth are arranged on the inner side of the winch rotating frame, and the winch rotating frame is connected with the servo motor through a gear; the base is further provided with a rotating wheel and a guide rail, the rotating wheel is used for supporting and guiding the winch rotating frame during rotation, and the guide rail is used for guiding the flexible probe rod.

7. The seabed geotechnical in-situ multi-parameter detection system according to claim 5, wherein a clamping plug is arranged at one end of the male plug; a groove is formed in one end of the female plug, and a clamp spring is embedded in the groove; three notches are evenly formed in the outer edge of the groove, and a clamping jaw is installed at each notch; the clamping jaw is nested on the clamp spring, and the other end of the female plug is connected with a gland through a screw; and the clamping plug of the male plug is plugged into the groove of the female plug, and the clamping spring is used for providing inward tightening acting force to buckle the clamping jaw with the clamping plug on the male plug.

8. A seabed geotechnical in-situ multi-parameter detection method, wherein the seabed geotechnical in-situ multi-parameter detection method is applied to a seabed geotechnical in-situ multi-parameter detection system according to claim 1, and the seabed geotechnical in-situ multi-parameter detection method comprises the following steps:
in the penetration process of a static sounding probe, controlling a winch in a butt joint assembly system to rotate, so that the winch drives a flexible probe rod to be laid;
controlling a servo motor to drive a driving rotating wheel to rotate, so that the driving rotating wheel drives rigid rod pieces to align with a butt joint device;
controlling a hydraulic locking oil cylinder to drive friction wheels to move in opposite directions, so that the two sides of the flexible probe rod are tightly attached to the friction wheels;
controlling hydraulic motors to drive the friction wheels to rotate so as to drive the flexible probe rod, so that the static sounding probe penetrates into a measured soil body; and
in the recovery process of the static sounding probe, controlling the hydraulic motors to rotate reversely to drive the friction wheels to drive the flexible probe rod so that the static sounding probe is pulled out upwards, meanwhile, controlling the butt joint device to open quick butt joint mechanisms between the adjacent flexible probe rods, dividing the straight probe rod into two sections of rigid rod pieces, and winding the rigid rod pieces on the winch after passing through the driving rotating wheel.

9. The method according to claim 8, wherein the integral frame comprises a support frame; and anti-collision grids and anti-collision rubber strips are arranged outside the support frame, a lifting frame is arranged on the top of the support frame, and an anti-corrosion zinc block is arranged inside the support frame.

10. The method according to claim 8, wherein the friction wheels are detachably connected with the supports, a groove is formed in the outer ring of the friction wheel, and lines are arranged on the groove.

11. The method according to claim 8, wherein the rigid rod piece is of a hollow cylinder structure, and quick connecting rod mechanisms are arranged at the two ends of the rigid rod piece respectively.

12. The method according to claim 11, wherein the quick connecting rod mechanisms comprise a male plug and a female plug.

13. The method according to claim 8, wherein the winch comprises a winch rotating frame, the winch rotating frame is installed on the base, annular teeth are arranged on the inner side of the winch rotating frame, and the winch rotating frame is connected with the servo motor through a gear; the base is further provided with a rotating wheel and a guide rail, the rotating wheel is used for supporting and guiding the winch rotating frame during rotation, and the guide rail is used for guiding the flexible probe rod.

14. The method according to claim 12, wherein a clamping plug is arranged at one end of the male plug; a groove is formed in one end of the female plug, and a clamp spring is embedded in the groove; three notches are evenly formed in the outer edge of the groove, and a clamping jaw is installed at each notch; the clamping jaw is nested on the clamp spring, and the other end of the female plug is connected with a gland through a screw; and the clamping plug of the male plug is plugged into the groove of the female plug, and the clamping spring is used for providing inward tightening acting force to buckle the clamping jaw with the clamping plug on the male plug.
